(19) United States
(12) Patent Application Publication
(10) Pub. No.: US 2019/0091613 A1
(43) Pub. Date: Mar. 28, 2019

(54) DIAPHRAGM STRUCTURE AND DIAPHRAGM VALVE INCLUDING SAME

(71) Applicant: Bitron Ind. China Co., Ltd., Qingdao (CN)

(72) Inventor: Dae Hong OK, Gyeonggi-do (KR)

(21) Appl. No.: 16/199,753

(22) Filed: Nov. 26, 2018

Related U.S. Application Data
(63) Continuation-in-part of application No. 15/264,849, filed on Sep. 14, 2016.

(30) Foreign Application Priority Data
Sep. 17, 2015 (KR) 10-2015-0131868

(51) Int. Cl. B01D 33/03; B01D 35/04; F16K 7/14

(52) U.S. Cl. CPC B01D 33/0307; F16K 7/14; B01D 35/04

(57) ABSTRACT

A diaphragm structure includes a vibrator, a first guide inserted into a lower side of the vibrator, a second guide inserted into a lower side of the first guide and having a part configured to protrude from an upper side of the vibrator, and a filtering member configured to filter introduced foreign matter, wherein the first guide and the filtering member are formed as one component integrally formed of a plastic material, and a plurality of filtering holes are formed in a side surface of the vibrator, which is positioned in a protruding direction of the second guide.

### CROSS-REFERENCE TO RELATED APPLICATION

This application is a Continuation-In-Part of co-pending application Ser. No. 15/264,849 filed on Sep. 14, 2016, which claims priority to the benefit of Korean Patent Application No. 10-2015-0131868 filed in the Korean Intellectual Property Office on Sep. 17, 2015, the entire contents of which are incorporated herein by reference.

### BACKGROUND

### 1. Field of the Invention

The present invention relates to a diaphragm structure and a diaphragm valve including same.

### 2. Discussion of Related Art

A diaphragm valve refers to a valve that adjust a flow of a fluid in the valve according to whether or not a diaphragm guide therein abutting the valve is in close contact with the valve. In order to move the diaphragm guide when liquid such as water flows into the diaphragm valve, holes are formed in the diaphragm guide. As a pressure with respect to the diaphragm guide is formed while the fluid passes through the holes formed in the diaphragm guide, whether or not the diaphragm guide is in close contact with the valve may be adjusted.

However, since the diaphragm valve is used, the holes of the diaphragm guide can be blocked by foreign matter present in water. When the holes of the diaphragm guide are blocked, the water does not flow freely into the diaphragm guide and thus it is difficult to change the pressure with respect to the diaphragm guide. Thus, the overall operational reliability of the diaphragm valve can be reduced and a desired valve operation cannot be performed.

### SUMMARY

An embodiment of the present invention is directed to a diaphragm structure capable of preventing operational reliability from being reduced due to foreign matter, and a diaphragm valve including the same.

Further, an embodiment of the present invention is directed to a diaphragm structure capable of improving operational reliability even with a simple structure, and a diaphragm valve including the same.

According to an aspect of the present invention, there is provided a diaphragm structure including a vibrator, a first guide inserted into a lower side of the vibrator, a second guide inserted into a lower side of the first guide and having a part protruding from an upper side of the vibrator, and a filtering member configured to filter introduced foreign matter.

The filtering member may be included in the first guide.

The filtering member may be formed at an outer periphery of the first guide.

The filtering member may be formed separately from the first guide and the second guide.

The filtering member may have a slit shape.

The filtering member may have a mesh shape.

According to another aspect of the present invention, there is provided a diaphragm valve including the diaphragm structure.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is an exploded perspective view illustrating a diaphragm structure according to an embodiment of the present invention;

FIG. 2 is a cross-sectional view illustrating the diaphragm structure according to the embodiment of the present invention; and

FIG. 3 is a cross-sectional view illustrating a diaphragm valve including the diaphragm structure according to the embodiment of the present invention.

### DETAILED DESCRIPTION

Hereinafter, exemplary embodiments of the invention will be described in detail with reference to the drawings. However, these are only examples and the invention is not limited thereto.

In descriptions of the invention, when it is determined that detailed descriptions of related well-known functions unnecessarily obscure the gist of the invention, detailed descriptions thereof will be omitted. Some terms described below are defined by considering functions in the invention and meanings may vary depending on, for example, a user's or operator's intentions or customs. Therefore, the meanings of terms should be interpreted based on the scope throughout this specification.

The spirit and scope of the invention is defined by the appended claims. The following embodiments are only made to efficiently describe the technological scope of the invention to those skilled in the art.

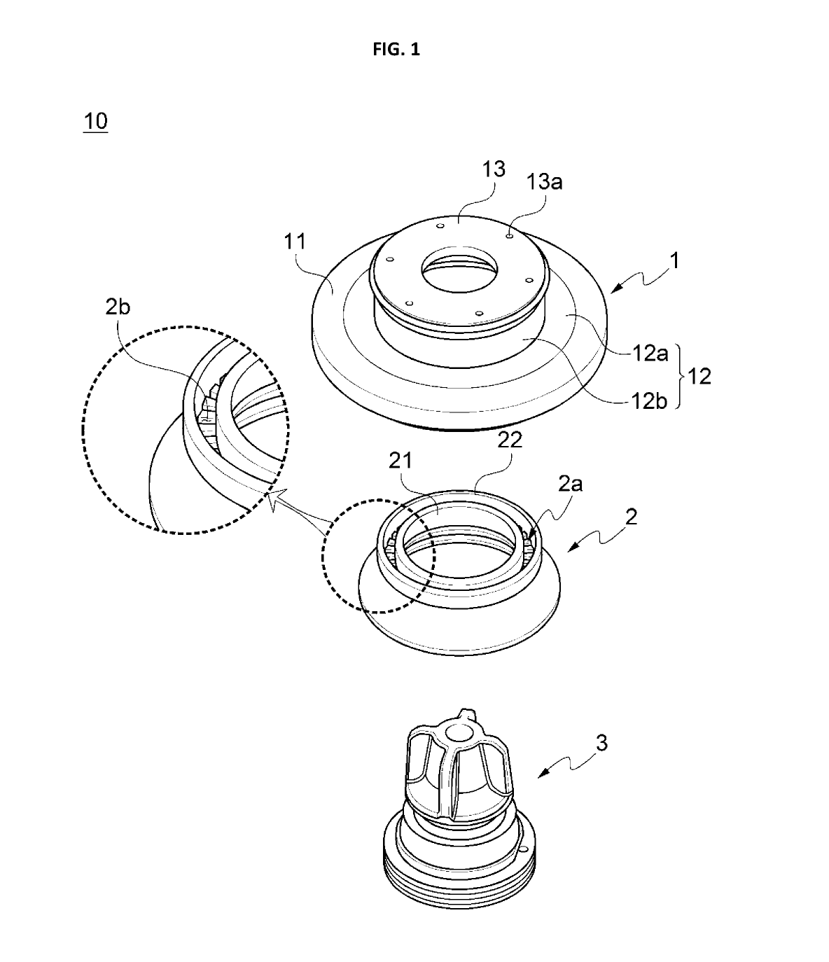

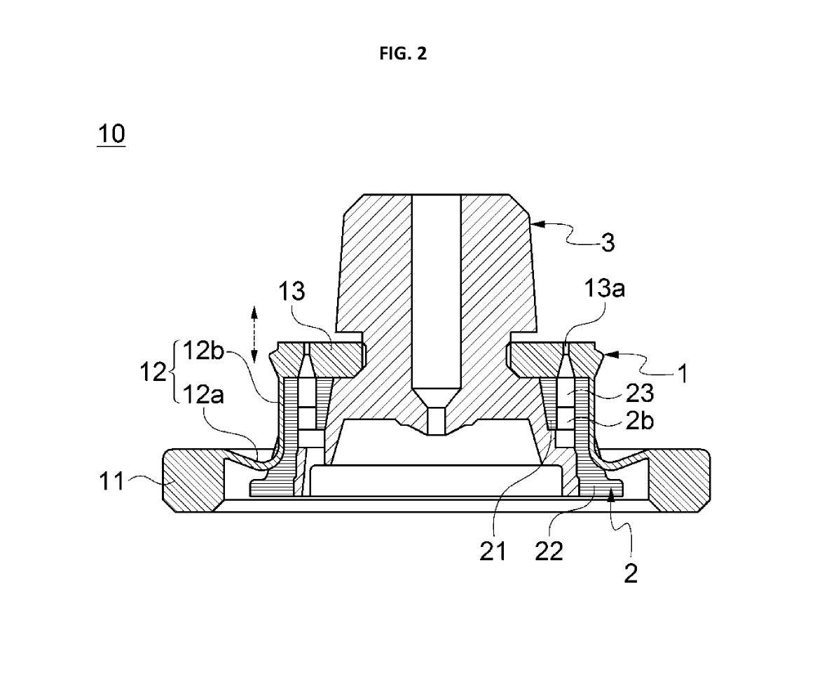

FIG. 1 is an exploded perspective view illustrating a diaphragm structure 10 according to an embodiment of the present invention, and FIG. 2 is a cross-sectional view illustrating the diaphragm structure 10 according to the embodiment of the present invention.

Referring to FIGS. 1 and 2, the diaphragm structure 10 may include a vibrator 1, a first guide 2 inserted into a lower side of the vibrator 1, and a second guide 3 inserted into a lower side of the first guide 2 and having a part protruding from an upper side of the vibrator 1.

The first guide 2 may include a filtering member 2a. The filtering member 2a may be a member for preventing an operation of a diaphragm valve from being interrupted due to the introduction of foreign matter, which is introduced into the diaphragm structure 10, into the diaphragm valve. The first guide 2 may be molded in plastic, and the filtering member 2a may be formed of the same material as the first guide 2. Further, the filtering member 2a may be formed simultaneously in a process of forming the first guide 2. That is, the first guide 2 including the filtering member 2a may be formed through injection molding and the like. Accordingly, a cost increase caused by the formation of the filtering member 2a may be minimized.

The filtering member 2a may be formed along an outer periphery of the first guide 2. The filtering member 2a may have a slit shape or a mesh shape. Since the diaphragm structure 10 may be moved smoothly in the diaphragm valve by the filtering member 2a according to water pressure, a problem may be prevented from occurring in the operation of the diaphragm valve.

In the present embodiment, the filtering member 2a is described as being included in the first guide 2, but the invention is not limited thereto. The filtering member 2a may also be formed separately from the first guide 2 and the second guide 3. That is, as the filtering member 2a is formed as a separate member having a mesh or screen form, the filtering member 2a may perform a filtering function by closely approaching any one of the first guide 2 and the second guide 3.

More specifically, the first guide 2 and the filtering member 2a of the diaphragm structure 10 according to the embodiment of the present invention may be formed as one component integrally formed of a plastic material. A plurality of filtering holes 13a for primarily filtering foreign matter which is introduced from the outside may be formed in one surface of the above-described vibrator 1, which is positioned in the inserting direction of the second guide 3.

Accordingly, in the diaphragm structure 10 according to the embodiment of the present invention, external foreign matter is primarily filtered through the plurality of filtering holes 13a and secondarily filtered through the filtering member 2a so that the external foreign matter is directly introduced into the filtering member 2a. Therefore, it is possible to prevent the filtering member 2a made of a plastic material from being damaged or broken and to effectively prevent the operation of the diaphragm valve from being interrupted due to the introduction of the foreign matter into the diaphragm valve.

Further, each of the plurality of filtering holes 13a described above may be formed in an axial direction of the vibrator 1 and may be formed to have a cylindrical shape with a constant diameter in an axial direction of a fluid flow and to have a conical shape in which a diameter thereof gradually increases in a flow direction of the fluid. That is, the fluid may pass through the cylindrical region in which a flow cross-sectional area is uniform and flow into the conical region in which a flow cross-sectional area increases in the process in which the fluid flows through the filtering holes 13a so that the fluid from which the foreign matter at an inlet of the filtering hole 13a is filtered may smoothly flow due to the increase of the flow cross-sectional area.

Meanwhile, the foreign matter (sand or the like) contained in the fluid which is introduced into the diaphragm valve may typically be formed to have a size having a cross-sectional area of 1 to 2 mm² in a direction perpendicular to the fluid flow direction. Therefore, in order to increase a filtration effect of the foreign matter contained in the fluid and to maintain a smooth flow of the fluid, an area (an area of the vibrator 1 in a direction perpendicular to the axial direction) of the inlet of the filtering hole 13a through which the fluid is introduced may be in the range of 0.1 to 1 mm². Accordingly, the external foreign matter may be prevented from being introduced into the diaphragm valve.

Meanwhile, the above-described vibrator 1 may include an annular fixing unit 11, which is not moved in the diaphragm valve and is fixed in position, a connecting unit 12, which is formed to extend in a radial direction and the axial direction at the fixing unit 11 so as to be bent and is movable by a predetermined distance in the axial direction by water pressure in the diaphragm valve, and a raised and lowered unit 13, which is formed to extend in an annular shape at an end of the connecting unit 12 and to be raised and lowered by a predetermined distance according to the movement of the connecting unit 12 described above.

In this case, the above-described connecting unit 12 may include a first connecting unit 12a, which is formed to extend inward from an inner circumferential surface of the fixing unit 11 so as to be bent and is movable according to the water pressure in the diaphragm valve, and a second connecting unit 12b which is formed to extend in a direction parallel to the axial direction at an end of the first connecting unit 12a.

Meanwhile, the plurality of filtering holes 13a described above may be formed in the raised and lowered unit 13, and each of the plurality of filtering holes 13a may be positioned directly above the filtering member 2a in the axial direction of the vibrator 1. That is, the plurality of filtering holes 13a may be formed on an extension line in the axial direction at a position at which the filtering member 2a is formed.

Further, the plurality of filtering holes 13a may be spaced apart from each other in a circumferential direction of the vibrator 1 and each positioned in the filtering member 2a with respect to the axial direction of the vibrator 1. That is, a vertical position of each of the plurality of filtering holes 13a may be located between an inner circumferential surface and an outer circumferential surface of the filtering member 2a.

As described above, each of the plurality of filtering holes 13a and the filtering member 2a may be formed so as to be positioned on a straight line in the axial direction of the vibrator 1, and the fluid (water) may pass through the filtering holes 13a and the filtering member 2a, which are connected in a straight line, and be introduced into the diaphragm valve so that the fluid may move smoothly.

Further, the first guide 2 and the second guide 3 described above may be in contact with and supported by at least a part of the vibrator 1. Specifically, parts of outer surfaces of the first guide 2 and the second guide 3 described above may be in contact with and supported by the raised and lowered unit 13 of the vibrator 1 described above and may not be in contact with the fixing unit 11.

Accordingly, the first guide 2 and the second guide 3 may also be raised and lowered together with each other as the raised and lowered unit 13 is raised and lowered by a change in water pressure in the diaphragm valve, and it is possible to prevent twisting or the like from occurring during movement in the axial direction through the contact and support between the first guide 2 and the second guide 3 and the raised and lowered unit 13.

Further, the above-described first guide 2 may include a first support wall 21 having an annular-shaped radial cross section and having an inner circumferential surface into which the second guide 3 is supportedly inserted, and a second support wall 22 having an annular-shaped radial cross section and having an outer circumferential surface which is supportedly inserted into the vibrator 1. That is, the first guide 2 may include the first support wall 21 and the second support wall 22, which are formed to be parallel to each other in the axial direction.

In this case, the above-described filtering member 2a may be formed between the first support wall 21 and the second support wall 22, and the first support wall 21 and the second support wall 22 may be connected by the filtering member 2a.

Meanwhile, the above-described filtering member 2a may include a plurality of slits 2b. Specifically, the above-described filtering member 2a may be formed to include the plurality of slits 2b formed between the first support wall 21 and the second support wall 22. In this case, an area of each of the plurality of slits 2b in a direction perpendicular to the axial direction of the vibrator 1 may be in the range of 0.1 to 1 mm². Accordingly, the external foreign matter may be prevented from being introduced into the diaphragm valve.

Further, an annular chamber 23, in which foreign matter is trapped, may be formed between the vibrator 1 and the filtering member 2a with respect to the axial direction of the vibrator 1. That is, the above-described filtering member 2a may be spaced apart from the raised and lowered unit 13 of the vibrator 1, and the annular chamber 23, which is formed by the separation of the first support wall 21 and the second support wall 22, may be formed between the raised and lowered unit 13 and the filtering member.

Accordingly, the foreign matter, which passes through the filtering holes 13a and is introduced into the annular chamber 23, may be trapped in the annular chamber 23 without passing through the filtering member 2a. Therefore, it is possible to prevent the foreign matter from being accumulated between the slits 2b at a specific point or a specific region along a flow path of the fluid.

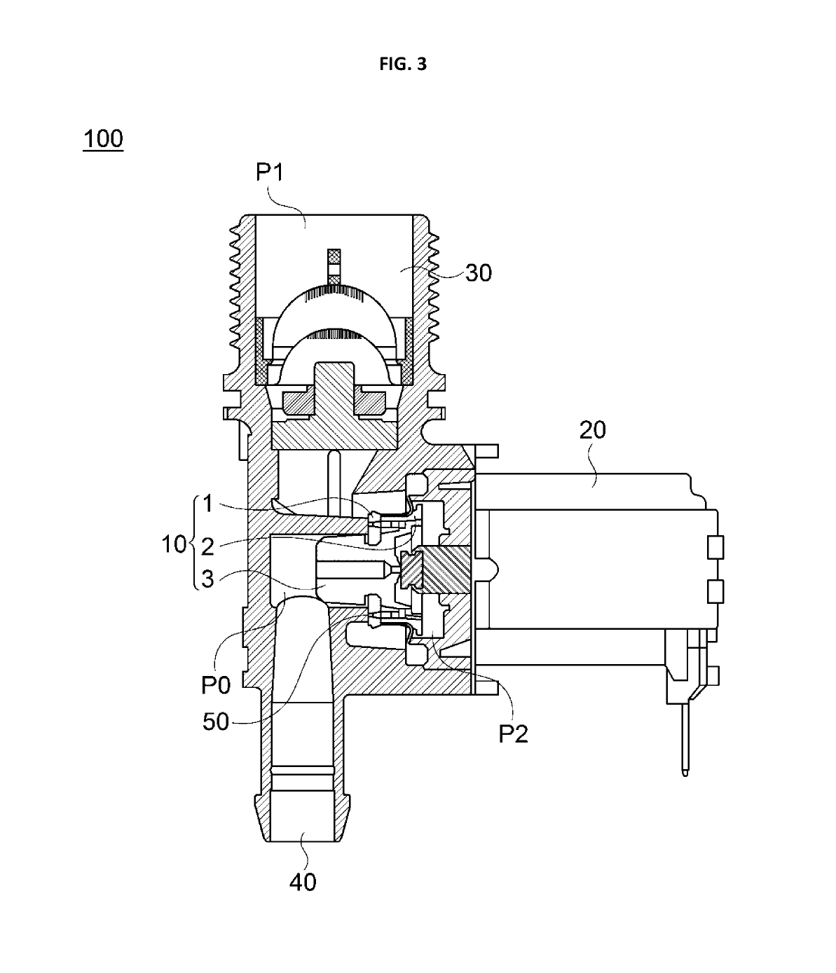

FIG. 3 is a cross-sectional view illustrating a diaphragm valve 100 including the diaphragm structure 10 according to the embodiment of the present invention.

Referring to FIG. 3, the diaphragm valve 100 may be driven as follows.

When a fluid (water) having a water pressure P1 is applied to a water inlet unit 30, an upper side of the diaphragm structure 10 may be filled with the fluid passing through holes formed in the diaphragm structure 10. When a solenoid 20 is in an off state, a pressure P1 of the water inlet unit 30 may be the same as a pressure P2 of the upper side of the diaphragm structure 10. In this case, an orifice 50 is closed by a force pressing the diaphragm structure 10 down, and thus the fluid may not be discharged to a water outlet unit 40.

At this time, a pressure P0 of an outside of the orifice 50 may be atmospheric pressure.

When the solenoid 20 is turned on, a central hole of the diaphragm structure 10 may be opened. Then, the fluid in the upper side of the diaphragm structure 10 passes through the central hole of the diaphragm structure 10, the pressure P2 of the upper side of the diaphragm structure 10 becomes lower than the pressure P1 of the water inlet unit 30, and the diaphragm structure 10 may be raised up by the water pressure of the water inlet unit 30. Therefore, the orifice 50 is opened and the fluid may be discharged to a side of the water outlet unit 40.

When the solenoid 20 is turned off again, the central hole of the diaphragm structure 10 is blocked, and the upper side of the diaphragm structure 10 may be refilled with the fluid through the holes formed in the diaphragm structure 10. Then, the orifice 50 is closed by the force pressing down at the upper side of the diaphragm structure 10, and thus the fluid may not be discharged to the water outlet unit 40.

Even when foreign matter is included in the fluid introduced from the water inlet unit 30 in this process, since the foreign matter is filtered by the filtering member 2a formed in the diaphragm structure 10, blockage of the holes through which the fluid flows by the foreign matter does not occur and it is thereby possible to prevent a problem in the operation of the diaphragm valve 100 from occurring.

According to the embodiments of the present invention, as a filtering member is formed in a diaphragm structure, operational reliability may be prevented from being reduced.

Further, according to the embodiments of the present invention, as a filtering member is formed in a first guide of a diaphragm structure or a separate filtering member is formed, operational reliability may be prevented from being reduced with only a simple configuration.

While the present invention has been described above in detail with reference to representative embodiments, it may be understood by those skilled in the art that the embodiment may be variously modified without departing from the scope of the present invention. Therefore, the scope of the present invention is defined not by the described embodiment but by the appended claims, and encompasses equivalents that fall within the scope of the appended claims.

What is claimed is:

1. A diaphragm structure comprising:
a vibrator;
a first guide inserted into a lower side of the vibrator;
a second guide inserted into a lower side of the first guide, a part of the second guide protruding from an upper side of the vibrator; and
a filtering member configured to filter introduced foreign matter,
wherein the first guide and the filtering member are formed as one component integrally formed of a plastic material, and
a plurality of filtering holes are formed in the upper side of the vibrator in a direction in which the inserting direction of the second guide is inserted into the lower side of the first guide.

2. The diaphragm structure of claim 1, wherein the first guide and the second guide are in contact with and supported by at least a part of the vibrator.

3. The diaphragm structure of claim 1, wherein the first guide includes:
a first support wall having an annular-shaped radial cross section and having an inner circumferential surface into which the second guide is supportedly inserted; and
a second support wall having an annular-shaped radial cross section and surrounding the first support wall with a predetermined distance, and having an outer circumferential surface which is supportedly inserted into the vibrator.

4. The diaphragm structure of claim 3, wherein the filtering member is formed between the first support wall and the second support wall.

5. The diaphragm structure of claim 1, wherein the filtering member includes a plurality of slits.

6. The diaphragm structure of claim 1, wherein the plurality of filtering holes are spaced apart from each other in a circumferential direction of the vibrator and each positioned in the filtering member with respect to an axial direction of the vibrator.

7. The diaphragm structure of claim 1, wherein each of the plurality of filtering holes are positioned directly above the filtering member in an axial direction of the vibrator.

8. The diaphragm structure of claim 1, wherein an annular chamber, in which foreign matter is trapped, is formed between the vibrator and the filtering member.

9. The diaphragm structure of claim 1, wherein an area of each of the plurality of filtering holes in a direction perpendicular to an axial direction of the vibrator is in a range of 0.1 to 1 mm².

10. The diaphragm structure of claim 5, wherein an area of each of the plurality of slits in a direction perpendicular to an axial direction of the vibrator is in a range of 0.1 to 1 mm².

11. A diaphragm valve comprising the diaphragm structure of claim 1.

12. A diaphragm structure comprising:
a vibrator comprising an annular fixing unit, a connecting unit extended from the fixing unit, and a raised and lowered unit formed to extend in an annular shape having a hole therein at an end of the connecting unit and to be raised and lowered by a predetermined distance according to a movement of the connecting unit, the raised and lowered unit having a plurality of filtering holes;
a first guide formed on a lower surface of the raised and lowered unit;
a second guide inserted into the hole, a part of the second guide protruding from the hole; and
a filtering member to filter introduced foreign matter, the filtering member formed along an outer periphery of the first guide, the filtering member directly below the plurality of holes in an axial direction of the vibrator.

13. The diaphragm structure of claim 12, wherein the first guide and the filtering member are formed as one component integrally formed of a plastic material.

14. The diaphragm structure of claim 12, wherein the first guide includes:
a first support wall having an annular-shaped radial cross section and having an inner circumferential surface into which the second guide is supportedly inserted; and
a second support wall having an annular-shaped radial cross section and surrounding the first support wall with a predetermined distance, and having an outer circumferential surface which is supportedly inserted into the vibrator.

15. The diaphragm structure of claim 12, wherein the filtering member includes a plurality of slits.

16. The diaphragm structure of claim 12, further comprising an annular chamber between the vibrator and the filtering member.

17. The diaphragm structure of claim 1, wherein an area of each of the plurality of filtering holes in a direction perpendicular to an axial direction of the vibrator is in a range of 0.1 to 1 mm².

18. A diaphragm valve comprising the diaphragm structure of claim 12.
